(19) United States
(12) Patent Application Publication
(10) Pub. No.: US 2016/0120362 A1
(43) Pub. Date: May 5, 2016

(54) Improved Electric Toaster

(71) Applicant: Kenwood Limited, Havant, Hampshire (GB)

(72) Inventors: Robert Fields, Havant, Hampshire (GB); Paul Palmer, Havant, Hampshire (GB); Sivaprakash Shanmugam, Havant, Hampshire (GB)

(21) Appl. No.: 14/896,734

(22) PCT Filed: Jun. 12, 2014
(86) PCT No.: PCT/GB2014/051815

§ 371 Date: Dec. 8, 2015

(30) Foreign Application Priority Data
Jun. 13, 2013 (GB) 1310537.4

(51) Int. Cl. A47J 37/08

(52) U.S. Cl. CPC A47J 37/08

(57) ABSTRACT

An electric toaster with a toasting chamber for a food item, having radiant heaters arranged on opposite sides thereof, and a microwave generator for internally heating the food item. The radiant and the internal heaters can be controlled separately by the user to achieve a required combination of internal and external temperature/texture.

This invention relates to electric toasters.

In principle, electric toasters have changed little since their invention in the 1950's; typically utilising one or more radiant heaters to heat and brown slices of bread. The radiant heaters used over the years have taken many different forms, although the most commonly used heaters comprise ribbon-like electrical conductors wound on insulating supports made of electrically insulating material, such as mica, to create planar heaters of similar dimensions to the bread being toasted.

Alternative heating arrangements have included devices such as ceramic heaters and tubular infra-red lamps, such as halogen lamps, and the convective heating has sometimes been fan-assisted. All conventional heating techniques, however, operate by applying heat to the external surfaces of the bread.

The limiting factor for the amount of heat applied to a piece of bread is the rate at which the outside surface will brown, and ultimately blacken (burn). If a high level of heating is applied by radiation to the external bread surfaces, these will burn in just a few seconds, whereas the inside of the bread is not heated sufficiently to create “good” toast. On the other hand, if lower-level heating is applied for a longer time, allowing the radiant heat time to conduct thought the bread into the centre, the toasting process is significantly longer. The toasting time can be as much as 2-3 minutes, and this is not always acceptable, especially as a significant part of this time (typically as much as 60 seconds) is heating element warm-up time.

The determination of what is “good” toast is also subjective and people like to be able to adjust the application of the heat to the bread to produce their specific requirement. Such adjustment also allows the toaster to satisfactorily work with differing bread types and sizes, as some bread has differing heat conductivity levels and therefore requires the heat application to be altered. This adjustment of the toaster is currently achieved using a single control that alters either the temperature of the heating elements or their operating time, or both.

Some toasters are additionally capable of monitoring the colour of the bread, so that the heating elements can be switched off automatically when the toasting process has achieved a user-selected level of surface browning of the bread. Moreover, many toasters also have the facility to operate in accordance with pre-programmed heat profiles for specific operations, such as defrosting product and/or cooking bagels and the like.

Despite such flexibility and sophistication, however, there are requirements to deliver toast of good quality in a shorter time than current toasters and also give users greater control over the flavour and consistency of the finished piece of cooked toast, thereby allowing more people to achieve their idea of “good toast” and also allow the cooking of a wide variety of breads. The present invention addresses these requirements.

According to the invention there is provided an electric toaster comprising a toasting chamber arranged closely to receive at least one food item to be heated, the item(s) having opposed major surfaces, a support for supporting the food item(s) at a toasting location within the chamber, first heating means for applying radiant heat to opposed major surfaces of said food item(s) in the chamber, second heating means for internally heating the food item(s), and individual user-operable control means for separately controlling the amounts of heat applied to the food item(s) by said first and second heating means respectively.

Accordingly, the toaster of the invention comprises independently operable heating means which can be used, together and/or in sequence, to apply heat to the exterior and interior respectively of the food item(s) so as to achieve a required internal temperature/texture, and external temperature/texture, or combination thereof. The chamber may be arranged to receive two or more items of food, which may be thin food items, such as slices of bread, sandwiches, rolls etc.

Preferably, the first heating means comprises fast-response infrared heating elements to provide intense heat sufficient to cause the external; surfaces of the food item(s) to brown very quickly. Such fast-response elements may comprise, for example, tungsten or carbon elements, or quartz-halogen lamps, for example.

The first heating means may comprise first and second radiant heating means adapted respectively to heat the major surfaces of a food item, such as a slice of bread, for example by being arranged on opposite sides of the chamber.

In some preferred embodiments of the invention, the first and second radiant heating means are substantially identical, and may be arranged to be substantially equidistant from the chamber. Thus in use the heaters apply equal radiant heat to each side of the food item(s) to achieve even browning. In some such circumstances, the first and second radiant heating means are subjected to common control. Alternatively, the first and second radiant heating means may be individually controllable, so that they can be set at different heating levels.

In some preferred embodiments of the invention, the first and second radiant heating means comprise different forms of infra-red heater.

In any event, it is preferred that the second heating means, for internally heating the food item(s), comprises a microwave generator, such as a magnetron, configured to heat very quickly the whole foodstuff (including the inside).

Importantly, the first and second heating means can be independently controlled, giving the user a vast amount of control over the outcome of the toast. Furthermore, since the second heating means is effective ab initio to warm the interior of the food item(s), instead of waiting for radiated heat from the surface to conduct through to the interior, the amount of heat used to brown the outside of the bread can be increased, and therefore the time reduced for total toast cooking.

In one example, acceptable toast can be made in less than 20 seconds by running the microwave and the infrared heating at the same time.

In preferred embodiments of the invention, there is provided support means for supporting the foodstuffs in a predetermined position for heating. Typically the support means comprises a metallic grid, grille or mesh on which the food item(s) rest.

It is preferred in some embodiments of the invention to provide a mobile support means whereby the finished food item(s) can be moved from its heating position to a presentation position for removal from the toaster once a heating cycle has concluded.

Such a mobile support means may be automatically operated by electrical interconnection with the heating circuitry of the toaster and in response to the termination of a heating process. Alternatively, the mobile support means may be configured to operate by way of mechanical linkage to a lid or cover for the toasting chamber which is opened to remove the food item(s).

The lid or cover may be hinged to a base and may be formed with viewing windows so that the progress of the toasting process can be observed by a user.

It has been known in principle for many years that microwave and radiant heating can be used together; microwave being the prime heating agency whilst the radiant heating is used for surface browning. Disclosures of such arrangements can be found, for example, in GB-A-2152790; U.S. Pat. No. 4,728,763 and U.S. Pat. No. 4,771,154. However, these arrangements were all disclosed over twenty years ago and in the context of microwave ovens, and, despite all of the benefits provided, it is not believed that the beneficial organisation of microwave and radiant heating into a toaster has been recognised hitherto.

In another aspect, the invention comprises an electric toaster comprising means defining a toasting location for foodstuffs to be heated, support means for supporting the foodstuffs at said location, first heating means for applying radiant heat to exposed surfaces of said foodstuffs at said location, second heating means for internally heating the foodstuffs, and individual user-operable control means for separately controlling the amounts of heat applied to the foodstuffs by said first and second heating means respectively.

In order that the invention may be clearly understood and readily carried into effect, one embodiment thereof will now be described, by way of example only, with reference to the accompanying drawings, of which:

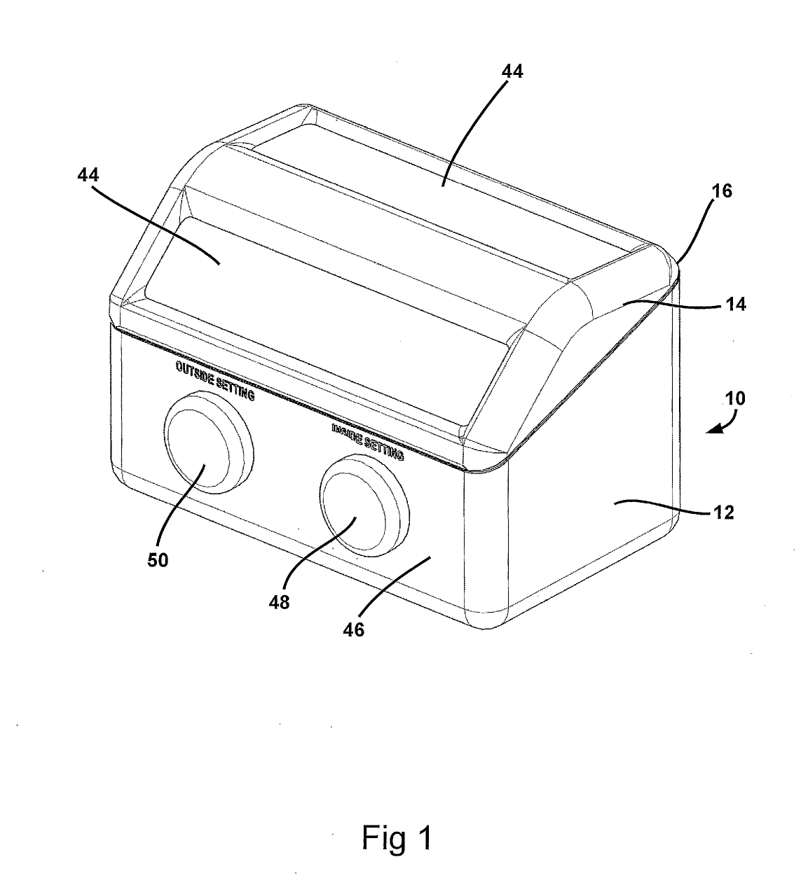

FIG. 1 shows a perspective external view of a toaster in accordance with one example of the present invention;

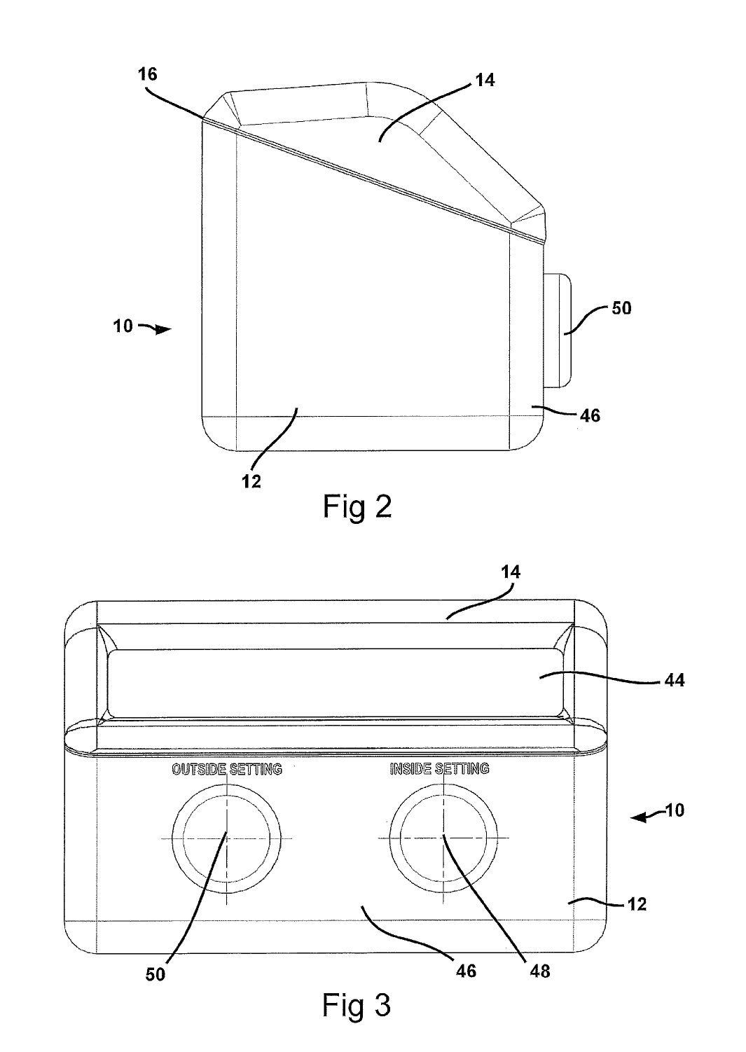

FIGS. 2 and 3 show respectively (but not to the same scale as FIG. 1) side and front elevational views of the toaster shown in FIG. 1;

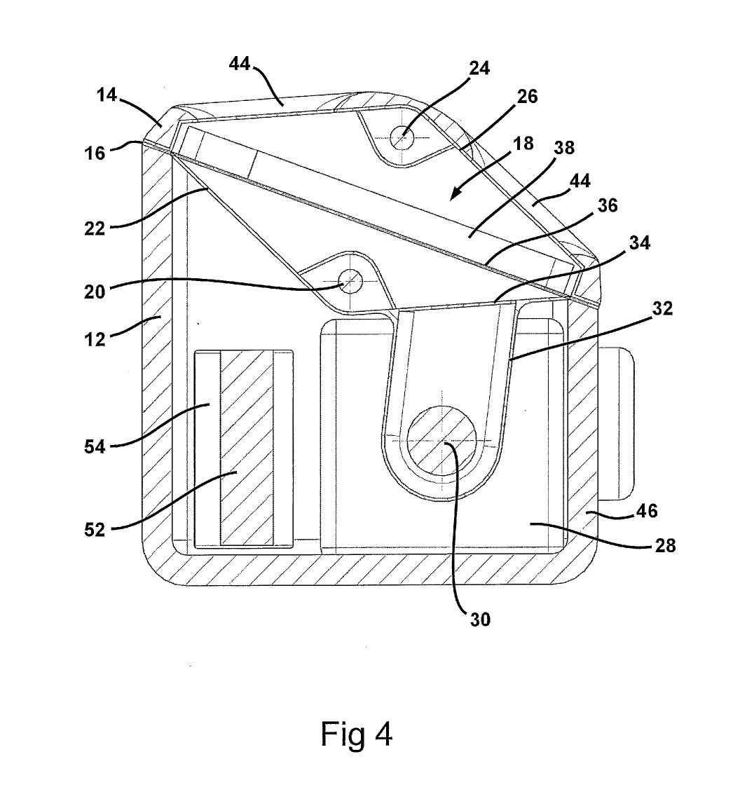

FIG. 4 shows a cross-sectional view through the toaster, taken parallel to the side elevation of FIG. 2;

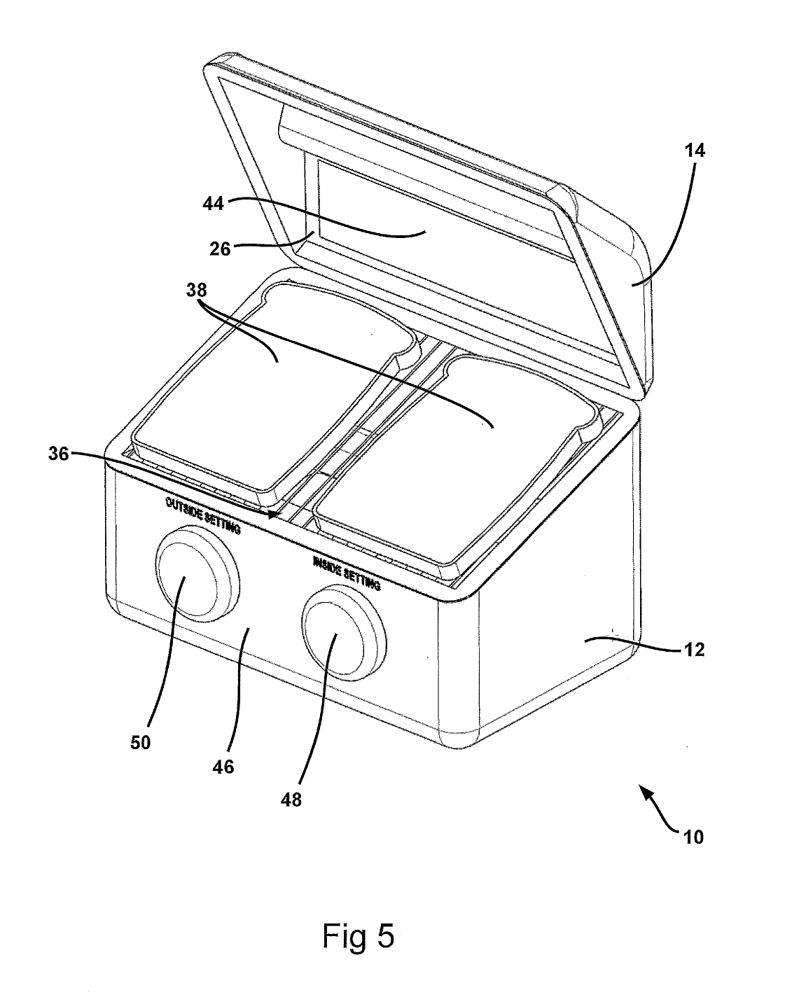

FIG. 5 shows a perspective external view of the toaster, similar to the view of FIG. 1 but with the toaster opened to illustrate the location of a toast support therein; and

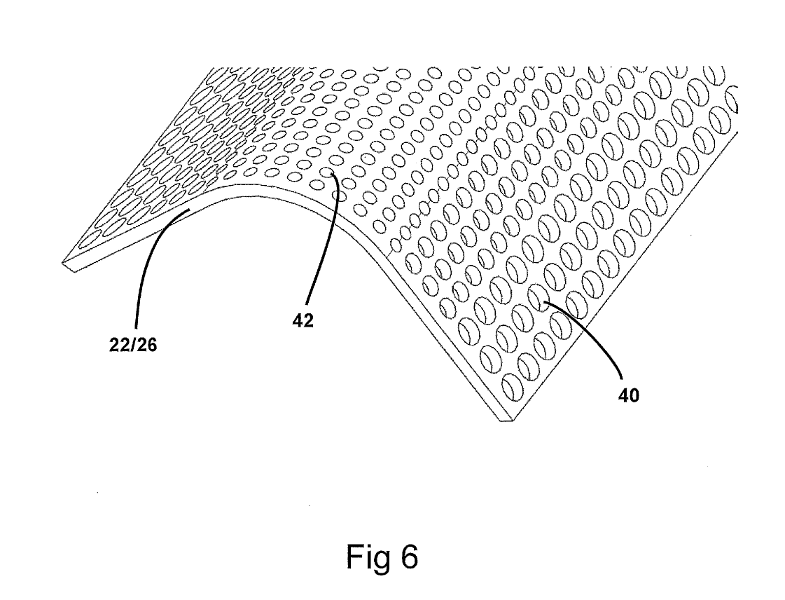

FIG. 6 shows a scrap perspective view of a microwave screen for use in the toaster.

Referring now to the drawings, a toaster 10 of this example consists of a main body 12 and a lid 14 connected to the main body 12 by way of a hinge 16 which permits the lid to be tilted open, allowing access to a toasting chamber 18 defined in part by components associated with both the main body and the lid.

As best seen in FIG. 4, a first, lower infrared heating element 20 is mounted in the main body 12, and has associated therewith a lower microwave shield 22 which also, in this embodiment, acts as a reflector for the lower infrared element 20. Mounted in the lid 14 is a second, upper infrared heating element 24 and an associated upper microwave shield 26 which can also act as a reflector for the radiant heat generated by the upper infrared element 24.

When the lid 14 is closed, the upper microwave shield 26 and the lower microwave shield 22 form boundaries of the toasting chamber 18, which is edge-sealed against microwave emission, for example by means of a quarter-wave choke (not shown). The sealing can be achieved in any other convenient manner, however, for example by providing complete electrical connection across the joint.

The microwave energy is generated by means of a magnetron device 28 housed within the main body 12, and is delivered by way of an antenna 30 contained within a waveguide 32 which connects to (or is part of) the lower microwave shield 22. A waveguide cover 34 is provided, configured and situated so as to prevent debris from entering the waveguide 32. The waveguide cover 34 may, for example, be made from mica or a similar material that is transparent to microwaves. The waveguide 32, upper microwave shield 26 and lower microwave shield 22 are all made from a material that is impervious to microwaves, such as sheet steel, aluminium or other similar known materials and are preferably polished to a highly reflective surface finish.

Inside the toasting chamber 18 there is provided an arrangement 36, such as a grille or mesh of wire-like or rod-like metallic elements, for supporting slices of bread 38 (or other foodstuffs) to be toasted. In the shown example, the grille or mesh of the arrangement 36 extends above, and across the face of, the lower microwave shield 22. This arrangement allows the bread 38 to be held in the correct position for toasting, and also presented for convenient removal and viewing. It will be appreciated that, whilst the bread 38 is, in this example, shown to be held inclined at an angle of about 20 degrees to the horizontal, any convenient disposition could be used, and the arrangement 36 could be configured in many different ways to support the bread 38 at any required angle, from horizontal to vertical.

Although the arrangement 36 is shown in this example to comprise a static grille or mesh, more complex mobile arrangements can be provided, if required, to actively position the bread 38 at a convenient location for removal from the toaster once the toasting process is complete. The movement of such a mobile arrangement may be spring-loaded and can be triggered to move in response to an automatic switching-off of the heaters at the end of a toasting cycle. Alternatively, or in addition, the mobile arrangement may respond to the opening of the lid 14 by a user. In this latter respect, the hinge 16 which connects the lid 14 to the main body 12 of the toaster may include caroming elements bearing against suitably shaped surfaces to provide a so-called “living hinge” system which can provide differing degrees of resistance to movement at various points in the opening and closing movements of the lid.

The infra-red heating elements 20 and 24 are provided to heat the external surfaces of the bread 38, and preferably comprise fast-response heaters such as tubular IR heaters in the form of quartz halogen lamps with tungsten filaments, but any suitable heater can be used. Instead of taking the form of linear tubes, the elements 20 and 24 can alternatively be round or “U” shaped.

In any event, if the infrared elements 20 and 24 cannot be safely exposed to microwave energy, they must be appropriately configured, and/or protected behind shields such as 22 and 26; these shields being constructed of microwave energy proof material perforated (as shown in FIG. 6) with arrays of small holes such as 40, of diameter approximately 1 mm to 2 mm, which block microwaves but admit the infrared energy from the heater lamps 20 and 24 to pass, thus allowing the IR energy to brown the bread 38.

The size and positioning of the holes such as 40 can be altered to allow more or less infrared energy through to certain parts of the bread 38. Accordingly, the shields 22 and 26 may be provided with smaller holes such as 42 where the infrared elements 20 and 24 are closest to the bread but with the bigger holes such as 40 to allow more energy through to travel the longer distance to the edges of the bread 38. Alternatively, the holes in the shields 22 and 26 could be uniformly sized, but their quantity or spacing can be changed over the shields, so as to vary the amount of infrared energy allowed through. If the infrared elements 20 and 24 are constructed, for example as described in the aforementioned U.S. Pat. No. 4,728,763, and thus able to be safely exposed to microwave energy, the shields 22 and 26 may be down-graded, or even dispensed with.

The lid 14 and the upper microwave shield 26 are formed with viewing windows 44 formed as metal shields similar in design to the shields 22 and 26 and substantially as used in current microwave oven viewing windows. These viewing windows 44 are preferably covered with glass to contain smells or vapours. Indeed, any of the windows and/or shields utilised in the toaster 10 may be formed by printing or otherwise depositing metallised layers of material onto a suitable glass or ceramic substrate.

The front panel 46 of the main body 12 presents, in this example, a pair of control dials 48 and 50 which allow a user to individually required toasting temperatures for the inside and the outside respectively of the bread 38. Alternatively, the individual heating controls could take forms other than rotatable dials. Slider switches could be used instead, for example, or if preferred any form of electronic control could be employed, such as a graphical user interface, incorporating a touch screen for example, or a form of gesture control. The external and internal heating controls can alternatively, or in addition to any of the foregoing arrangements, be configured for operation by means of remote controllers, communicating with the toaster 10 via any convenient form of wireless connection (such as Bluetooth, WiFi etc.). Additional control options or commonly used features (such as defrosting or re-heating) can also be operated by the use of additional specific program buttons.

Both the microwave and infrared heaters can operate at the same time, at different times or during overlapping but offset periods, as dictated by user preference and the toasting performance aimed at. For example, a user may prefer to brown the toast a little via the infrared elements before adding the microwave energy to warm up the inside, or via versa.

Various options for the hinging of lid 14 and the possibility of linking the opening of the lid with a mobile support arrangement for presenting the finished toast at a convenient location with respect to the toaster 10 have already been mentioned. However, it will be appreciated that the lid 14 could alternatively be opened by mechanisms other than a hinge 14. For example, it could slide, hinge, pivot or be removed completely.

The opening of the lid 14 could also be linked electrically to an electronic control circuit 52 allowing the cooking to start when the lid is closed, or for the lid 14 to open automatically when the bread 38 has undergone the selected toasting cycle. The lid actuating mechanism may be automated, sprung or motor driven.

It can be seen from FIG. 4, in particular, that the magnetron 28 and its associated capacitor 54 are mounted low down inside the main body 12 of the toaster 10. Since these are heavy components, such mounting promotes good stability, whilst maintaining design envelope dimensions similar to those of conventional toasters.

Although the examples of the invention described hereinbefore have utilised a magnetron 28 to generate the microwave energy, alternative generators, such as solid state microwave generators, could be used instead if preferred.

It will be appreciated that the shape of the toasting chamber 18 can be changed, in accordance with design choice and in relation to structural and performance-related parameters of chosen components, such as the microwave scattering/reflecting properties of the shields, in order to ensure that every part of the bread 38 receives similar amounts of energy and therefore is uniformly heated.

In some embodiments of the invention, the infrared elements 20 and 24 are movable and can be caused to pass or “scan” over the bread 38, in order to achieve an even brownness level. In alternative such embodiments, the elements 20 and 24 remain fixed and the bread 38 is moved to pass under the infrared energy. Both embodiments allow a similar reflector design and the possibility of better browning evenness but at the expense of a more complex mechanism and therefore increased cost.

Electric toasters in accordance with the invention can be used for heating/cooking foodstuffs other than bread slices. Such alternative foodstuffs include food filled toasted sandwiches, food filled paninis or ciabattas etc.; with the benefit that the microwave energy heats the fillings to satisfactory temperature levels whilst the outside is only browned.

It will be appreciated that the upper and lower infra-red heaters used need not be of the same type and, even if they are notionally identical, their heat outputs may be adjustable relative to one another, so as to facilitate the use of different infra-red heating levels for the two major surfaces of the bread slice or other foodstuff being heated.

1-16. (canceled)

17. An electric toaster comprising:
a toasting chamber arranged to receive at least one food item to be toasted, the item having opposed major surfaces,
a support for supporting the at least one food item at a toasting location within the chamber,
a first heater for applying radiant heat to the opposing major surfaces of the at least one food item in the chamber,
a second heater for internally heating the at least one food item, and
individual user-operable controls for separately controlling the amount of heat applied to the at least one food item by the first and second heaters, respectively.

18. A toaster according to claim 17, wherein the first heater comprises fast response infrared heating elements.

19. A toaster according to claim 18, wherein the fast-response elements comprise one or more of tungsten or carbon elements, or quartz-halogen lamps.

20. A toaster according to claim 17, wherein the first heater comprises first and second radiant heaters arranged in opposite sides of the toasting chamber so as to heat the opposing major surfaces of the at least one food item.

21. A toaster according to claim 20, wherein the first and second radiant heaters are substantially identical.

22. A toaster according to claim 20, wherein the first and second radiant heaters are arranged to be substantially equidistant from the toasting location.

23. A toaster according to claim 20, wherein the first and second radiant heaters comprise different forms of infra-red heater.

24. A toaster according to claim 20, further comprising a common control for controlling the heat output from the first and second radiant heaters.

25. A toaster according to claim 20, further comprising individual controls for respectively controlling the heat output from the first and second radiant heaters.

26. A toaster according to claim 17, wherein the second heater comprises a microwave generator configured to rapidly heat an inner portion and an outer portion of the at least one food item.

27. A toaster according to claim 17, further comprising a support for supporting the at least one food item in a predetermined position for heating.

28. A toaster according to claim 27, wherein the support comprises a metallic grid, grill, or mesh.

29. A toaster according to claim 27, wherein the support comprises a mobile support adapted to move a finished at least one food item from the heating position to a presentation position for removal from the toaster.

30. A toaster according to claim 29, wherein the mobile support is automatically operated by electrical interconnection with heating circuitry of the toaster and in response to termination of a heating process.

31. A toaster according to claim 29, wherein the mobile support is adapted to operate by way of mechanical linkage to a lid or cover for the toasting chamber which is opened to remove the at least one food item.
